(19) United States
(12) Patent Application Publication
(10) Pub. No.: US 2009/0238028 A1
(43) Pub. Date: Sep. 24, 2009

(54) Method for producing composite materials such as thermoplastic resins with mineral and/or vegetable fillers

(75) Inventor: Massimo DE MARIA, Oggiona S. Stefano VA (IT)

Correspondence Address: JACOBSON HOLMAN PLLC, 400 SEVENTH STREET N.W., SUITE 600, WASHINGTON, DC, 20004, US

(73) Assignee: Meccaniche Moderne S.P.A.

(21) Appl. No.: 12/453,913

(22) Filed: May 27, 2009

Related U.S. Application Data
(62) Division of application No. 10/539,626, filed on Jun. 17, 2005.

(30) Foreign Application Priority Data
Dec. 20, 2002 (IT) MI2002A 002736

(51) Int. Cl. B29C 43/44; B01F 7/08; B29C 47/10; B01F 15/06

(52) U.S. Cl. 366/75; 366/76.6

(57) ABSTRACT

A method for producing composite materials, such as thermoplastic resins with mineral and/or vegetable fillers, consisting in feeding a mineral and/or vegetable filler, preheating the filler, feeding a melted thermoplastic resin onto the filler, introducing the mixture of the filler and the thermoplastic resin in an extruder, subjecting the mixture to high compression, producing a high partial vacuum, and compressing the mixture in an extrusion head, out of which the material to be subjected to subsequent treatments flows.

### TECHNICAL FIELD

The present invention relates to a method for producing composite materials, such as thermoplastic resins with mineral and/or vegetable fillers.

### BACKGROUND ART

A problem frequently encountered in the manufacture of articles made of thermoplastic resins filled with mineral and/or vegetable fillers is related to the possibility to achieve homogeneous and uniform mixing of the thermoplastic material and of the added mineral and/or vegetable elements, which can be constituted by powder, fibers, waste and so forth.

The solutions currently used do not allow to achieve intimate mixing between the filler and the thermoplastic material, and therefore discontinuities and weak regions can occur subsequently in the articles manufactured using the resulting composite material, leading to products of distinctly lower quality.

### DISCLOSURE OF THE INVENTION

The aim of the invention is to solve the above described problem by providing a method for producing composite materials, such as thermoplastic resins with mineral and/or vegetable fillers, that allows to obtain complete and uniform mixing between the resin and the fiber, achieving complete wetting of the fibers and total elimination of internal air.

Within this aim, an object of the invention is to provide a method that allows to avoid degradation of the resins and of the fibers that inevitably occurs when there is a prolonged contact between the melted polymer and the filler and/or fiber.

Another object of the present invention is to provide a method that allows to increase significantly the percentage of mineral and/or vegetable fillers, in powder or fiber form, without thereby leading to a particular degradation of the manufactured article produced with the composite material.

Another object of the present invention is to provide a method that can be obtained with a series of operating steps that can be performed with equipment generally used and is also particularly advantageous from a merely economical point of view.

This aim and these and other objects that will become better apparent hereinafter are achieved by a method for producing composite materials, such as thermoplastic resins with mineral and/or vegetable fillers, characterized in that it consists in feeding a mineral and/or vegetable filler, preheating said filler, feeding a melted thermoplastic resin onto said filler, introducing the mixture of said filler and said thermoplastic resin in an extruder, subjecting the mixture to high compression, producing a high partial vacuum, and compressing the mixture in an extrusion head, out of which the material to be subjected to subsequent treatments flows.

### BRIEF DESCRIPTION OF THE DRAWINGS

Further characteristics and advantages of the invention will become better apparent from the description of a preferred but not exclusive embodiment of a method for producing composite materials, such as thermoplastic resins with mineral and/or vegetable fillers, illustrated by way of non-limiting example with the aid of the accompanying drawings, wherein:

FIG. 1 is a schematic view of an apparatus for carrying out the method;

FIG. 2 is a schematic view of a profile head for obtaining finished articles, which can be arranged at the outlet of the extrusion head;

FIG. 3 is a sectional view of a sheet head that feeds a calendar in order to obtain sheets of different thicknesses;

FIG. 4 is a sectional view of a press with molds being fed with amounts of material that have a set weight and are then pressure-molded or vacuum-formed.

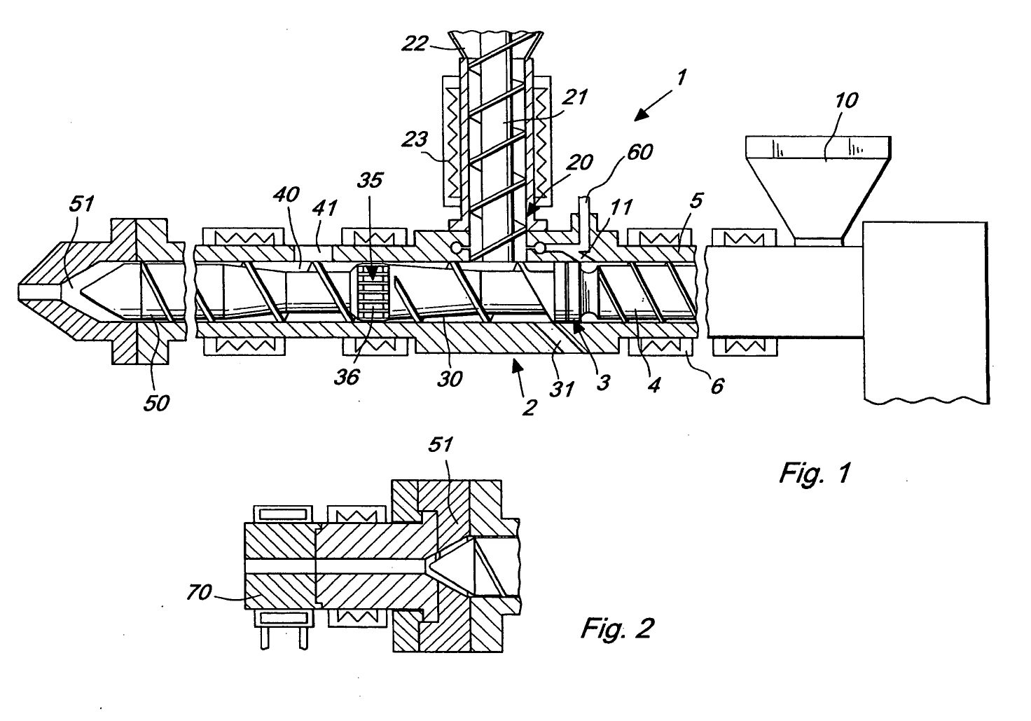

### WAYS OF CARRYING OUT THE INVENTION

With reference to the figures, an apparatus, generally designated by the reference numeral 1, is shown which has a body 2 inside which there is an extrusion screw that is generally designated by the reference numeral 3.

It is also optionally conceptually possible to use a twin-screw extruder instead of a single-screw extruder.

A first particularity of the invention consists in that the extrusion screw 3 has a first part, designated by the reference numeral 4, that can rotate inside a first cylindrical body 5 on which first heating means 6 act.

In the initial portion of the part 4 there is a hopper for loading the thermoplastic resin, which is designated by the reference numeral 10 and introduces metered quantities of material which are plasticized and then melted in order to be introduced in an injection channel 11 that has the particularity of introducing at least part of the thermoplastic resin directly at the end portion of a feeder 20 of mineral and/or vegetable fillers, which can be in powder or fiber form, such feeder having a feed screw 21 that draws from a loading hopper 22.

There are also preheating means 23 that are adapted to bring the mineral and/or vegetable filler to a preset temperature that can be selected from 20 to 160 degrees.

As mentioned earlier, a particularly innovative solution consists in that the melted thermoplastic resin is introduced at the end portion of the feed screw 21, so that the loads are wet by the plastic material before introduction in the extruder.

This allows to eliminate a larger amount of gas, and the fillers, which are not yet compacted, are coated in depth and, due to the high temperature to which they are subjected, the residual humidity of the filler is eliminated fully and exits upward, along the feed screw 21, further heating the fillers that follow along the feed.

The thermoplastic resin mixed with the fillers is introduced in the second portion 30 of the extrusion screw, where it undergoes, in an initial region, a first high compression that wets the filler and further expels the residual gases, which are conveyed outside by means of a first degassing vent 31.

After the high compression step, the thermoplastic resin mixed with the fillers is introduced in a mixer 35, which in practice is provided by means of a plurality of axial channels 36 that greatly reduce the cross-section and consequently increase the exposed useful surface of the mixture between plastic materials and fillers, enhancing the degassing step and further facilitating the wetting action.

At the output of the mixer 35, the product is subjected to a step of high expansion in the decompression portion 40, where a second degassing vent 41 is provided.

The region of high partial vacuum in practice causes the mixture to roll and relax, removing more easily any remaining gases, which can exit from the second degassing vent 41.

Downstream of the decompression portion 40 there is an extrusion portion. 50, where the material is compressed inside an extrusion head 51, which produces the outflow of the material to be subjected to optional further treatments.

It should be added to the above that it is possible to provide an auxiliary inlet 60, which allows to introduce a second thermoplastic resin to be mixed with the thermoplastic resin that is fed in the first portion; it is also possible to send the thermoplastic resin fed in the first portion only partially to the end of the loading hopper, in an amount that is in any case greater than 20%, while the remaining part of the material is fed directly into the second portion of the extrusion screw.

It should be further added that the fed resin is provided in percentages from 25 to 70% inside the first portion of the extrusion screw, while the second portion, which has at least twice the cross-section of the first one, also includes the filler in a percentage from 75 to 30%.

The filler is preferably constituted by mineral or vegetable elements in powder or fiber form, with a length from 3 to 20 mm.

It is also possible to introduce treatment waste up to a maximum of 30% by using the feeder 20.

Schematically, it is possible to indicate that the first portion of the extrusion screw has an axial extension of approximately 20 diameters, while the second portion where compression and partial vacuum occur has a length of approximately 14 diameters, including the end portion for final extrusion.

At the output of the extrusion head it is possible to provide, as shown in FIG. 2, a profile head 70 that allows to directly obtain finished manufactured articles that are extruded directly at the outlet of the extrusion head.

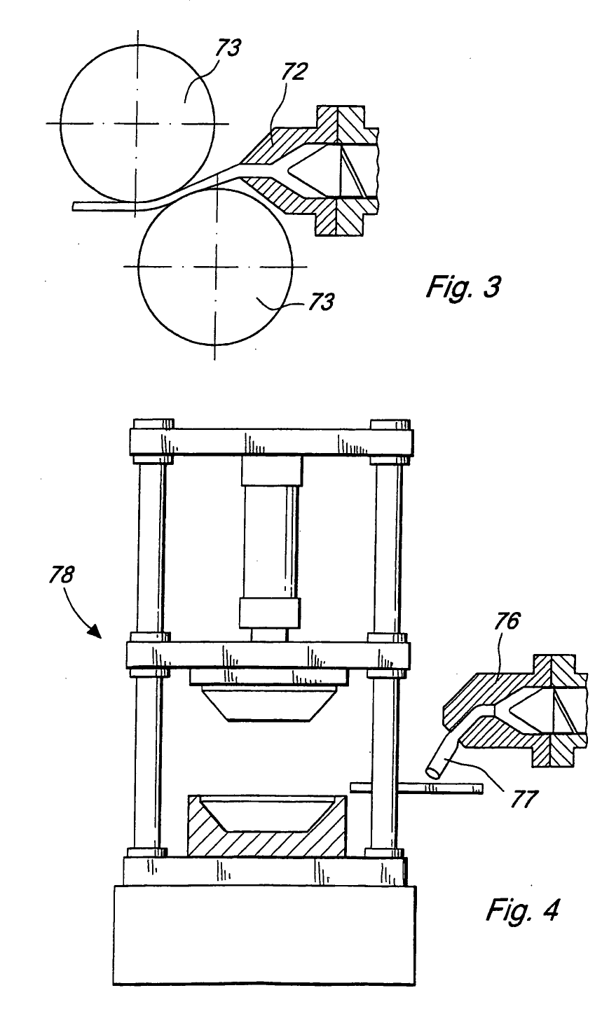

According to what is shown in FIG. 3, it is possible to provide a sheet head 72, downstream of which there are calendering rollers 73.

With reference to FIG. 4, it is possible to provide an extrusion head 76, from which a worm of product 77 having a preset weight exits, such worm being introduced directly into a press 78, the molds of which allow to manufacture the intended articles.

It is also possible to provide a spaghetti head for producing granules.

From what has been described above it is therefore evident that the invention achieves the intended aim and objects, and in particular the fact is stressed that an innovative technique is used which consists in introducing the thermoplastic resin in a region that is external with respect to the extrusion screw so that it is easier to achieve intimate mixing.

It should be added to the above that although in the examples cited above the first portion where the melting of the thermoplastic resin occurs is in axial alignment with the same extrusion screw and arranged thereon, it is obviously possible to provide a separate extrusion screw that feeds the thermoplastic material at the end of the feed portion of the feeder of mineral and/or vegetable fillers.

The invention thus conceived is susceptible of numerous modifications and variations, all of which are within the scope of the appended claims.

All the details may further be replaced with other technically equivalent elements.

Furthermore, the individual characteristics, given in relation to specific examples, may actually be interchanged with other different characteristics that exist in other examples of embodiments.

In practice, the materials used, as well as the contingent shapes and dimensions, may be any according to requirements.

The disclosures in Italian Patent Application No. MI2002A002736 from which this application claims priority are incorporated herein by reference.

1-21. (canceled)

22. A method for producing composite materials, with at least one of mineral and vegetable fillers, said method comprising the steps of:
feeding a thermoplastic resin into a first portion of an inner chamber of an extruder containing a rotatable extrusion screw;
plasticizing and melting said thermoplastic resin in said first portion of the inner chamber of the extruder;
conveying at least part of the melted thermoplastic resin out of said inner chamber of the extruder through an injection channel;
feeding said at least one of mineral and vegetable fillers in powder or fiber form through a filler feeder to a second portion of the inner chamber of the extruder arranged downstream of said first portion;
preheating said at least one of mineral and vegetable fillers in powder or fiber form before reaching said second portion of the inner chamber of the extruder;
feeding the melted thermoplastic resin through the injection channel into an end portion of the filler feeder arranged upstream of debouchment of the filler feeder into the second portion of the inner chamber of the extruder, thereby wetting the filler in powder or fiber form with the melted thermoplastic resin and mixing the filler in powder or fiber form and the melted thermoplastic resin before introduction into said second portion of the inner chamber of the extruder;
introducing the mixture of said filler and thermoplastic resin into the second portion of the inner chamber of the extruder;
further mixing said mixture of filler and thermoplastic resin in the inner chamber of the extruder; and
extruding the composite material through an extrusion head arranged at a downstream end of the extruder.

23. The method according to claim 22, wherein said at least one of mineral and vegetable fillers in powder or fiber form is heated to a temperature from 20° to 160°.

24. The method according to claim 22, wherein the thermoplastic resin is present in a percentage from 25 to 70% of the composite material being obtained and the filler is present in a percentage from 75 to 30%.

25. The method according to claim 22, wherein the mixture, after introduction into the second portion of the inner chamber of the extruder, is subjected to a high compression step in a compression region of the chamber, followed by a high depression step in an expansion region of the chamber.

26. The method according to claim 25, wherein said further mixing of the mixture of filler and thermoplastic resin in the inner chamber of the extruder takes place between said high compression step and high depression step.

27. The method according to claim 25, wherein a first degassing of the mixture is performed during the high compression step.

28. The method according to claim 25, wherein a second degassing of the mixture is performed during the high depression step.

29. The method according to claim 22, wherein, during said further mixing of the mixture of filler and thermoplastic resin in the inner chamber of the extruder, the exposed surface of the mixture components is increased, thereby enhancing degassing of the mixture and facilitating wetting of the filler by the melted thermoplastic resin.

30. The method according to claim 22, wherein the fibers of said at least one of mineral and vegetable fillers have a length from 3 to 20 mm.

31. The method according to claim 22, wherein the filler contains processing waste in a maximum quantity of 30%.

32. The method according to claim 22, wherein in said first portion of the inner chamber for the plasticizing and melting step of the thermoplastic resin the extrusion screw is used with an axial extension substantially corresponding to 20 times the screw diameter, while in said second portion of the inner chamber for high compression and depression steps the extrusion screw is used with an axial extension, including its end portion for final extrusion, substantially corresponding to 14 times the screw diameter.

33. The method according to claim 22, wherein the plasticizing and melting step of the thermoplastic resin occurs in axial alignment with the extrusion screw and arranged thereon.

34. The method according to claim 22, wherein the plasticizing and melting step of the thermoplastic resin occurs by an extrusion screw that is separate with respect to the extrusion screw used for processing the mixture of thermoplastic resin and filler.
